(19) United States
(12) Patent Application Publication
(10) Pub. No.: US 2024/0135129 A1
(43) Pub. Date: Apr. 25, 2024

(54) METHODS AND SYSTEMS FOR IDENTIFYING AND TAGGING BARCODES IN PDF FILES

(71) Applicant: Global Graphics Software Limited, Canbridge (GB)

(72) Inventor: Martin Bailey, Cambridgeshire (GB)

(21) Appl. No.: 17/971,419

(22) Filed: Oct. 20, 2022

(51) Int. Cl. G06K 19/06; G06F 40/106; G06F 40/166

(52) U.S. Cl. CPC G06K 19/06028; G06F 40/106; G06F 40/166

(57) ABSTRACT

A method for creating or modifying a PDF file includes inserting or identifying a barcode in the PDF file and adding metadata to, or modifying metadata in, the PDF file for the barcode, wherein the metadata includes a position of the barcode on at least one page, a symbology of the barcode, and data represented by the barcode. A method for locating, modifying, or replacing a barcode of a PDF file includes identifying metadata in the PDF file corresponding to the barcode, wherein the metadata includes a position of the barcode on at least one page, a symbology of the barcode, and data represented by the barcode and locating, modifying, or replacing the barcode in the PDF file using the metadata.

### FIELD

The present invention is directed to the area of identifying and tagging barcodes in a PDF file and using the PDF files to identify or modify the barcodes. The present invention is also directed to methods and systems for identifying and tagging barcodes in a PDF file and using the PDF files to identify or modify the barcodes.

### BACKGROUND

Portable Document Format (PDF) provides a widely supported, robust method for delivering graphically rich documents that can represent the graphics for printing workflows. Many PDF files contain barcodes. For example, marketing materials often include QR Codes; labels and packaging may include EAN, UPC, or other barcodes for scanning at a point of sale; and envelopes may use various different mailing barcodes for different postal services around the world. Flexibility in encoding barcodes means that it can be difficult for a PDF reader to identify a specific graphic or collection of graphics on a PDF page as representing a barcode.

### BRIEF SUMMARY

One embodiment is a method for creating or modifying a PDF file. The method includes inserting or identifying a barcode in the PDF file and adding metadata to, or modifying metadata in, the PDF file for the barcode, wherein the metadata includes a position of the barcode on at least one page, a symbology of the barcode, and data represented by the barcode.

In at least some embodiments, the metadata further includes at least one of a rotation of the barcode on the at least one page, position of text printed with the barcode, font or size of the text, foreground or background colors of the barcode, or an error correction factor. In at least some embodiments, to facilitate scaling or replacement of the barcode, the metadata further includes at least one of a minimum physical dimension of the barcode, a maximum physical dimension of the barcode, a bar width reduction, a bar width reduction along a print direction, a bar width reduction orthogonal to the print direction, or vertical or horizontal alignment for a replacement barcode.

In at least some embodiments, adding the metadata includes adding the metadata to an optional content group (OCG) that encodes graphical elements of the barcode in the PDF file. In at least some embodiments, adding the metadata includes adding the metadata to a Form or Image XObject that encodes graphical elements of the barcode. In at least some embodiments, adding the metadata includes adding the metadata and a unique identifier as extensible metadata platform (XMP) in a metadata stream at a document level, page level, or parent Form XObject level of the PDF file. In at least some embodiments, adding the metadata includes adding the metadata and a unique identifier using a PDF object structure or JSON (JavaScript Object Notation) stream within a document catalog, page object, or parent Form XObject.

Another embodiment is a method for locating, modifying, or replacing a barcode of a PDF file. The method includes identifying metadata in the PDF file corresponding to the barcode, wherein the metadata includes a position of the barcode on at least one page, a symbology of the barcode, and data represented by the barcode and locating, modifying, or replacing the barcode in the PDF file using the metadata.

In at least some embodiments, the metadata further includes at least one of a minimum physical dimension of the barcode or a maximum physical dimension of the barcode, wherein locating, modifying, or replacing the barcode includes scaling the barcode limited by the minimum physical dimension or the maximum physical dimension in the metadata.

In at least some embodiments, the metadata further includes at least one of a bar width reduction, a bar width reduction along a print direction, or a bar width reduction orthogonal to the print direction. In at least some embodiments, locating, modifying, or replacing the barcode includes scaling modules of the barcode utilizing any of the bar width reductions in the metadata.

In at least some embodiments, the metadata further includes at least one of a rotation of the barcode on the at least one page or vertical or horizontal alignment for a replacement barcode. In at least some embodiments, locating, modifying, or replacing the barcode includes replacing the barcode with a replacement barcode utilizing at least one of the location of the barcode on the at least one page, the rotation of the barcode on the at least one page, or the vertical or horizontal alignment for the replacement barcode in the metadata.

In at least some embodiments, locating, modifying, or replacing the barcode includes generating a variable data PDF file by including multiple instances of the PDF file and replacing the barcode in each of the instances with a different replacement barcode using the metadata. In at least some embodiments, the method further includes printing the PDF file.

A further embodiment is a system that includes at least one memory having instructions stored thereon and at least one processor coupled to the at least one memory and configured to execute the instructions to perform any of the methods described above. In at least some embodiments, the system further includes a printing device, wherein the instructions further include printing the PDF file.

Yet another embodiment is a non-transitory computer-readable medium having processor-executable instructions, the processor-executable instructions when installed onto a device enable the device to perform any of the methods described above.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1A is a block diagram of one embodiment of a writing system, according to the invention;

FIG. 1B is a block diagram of one embodiment of a reading system, according to the invention;

FIG. 2 is a flowchart of one embodiment of a method for creating or modifying a PDF file, according to the invention; and

FIG. 3 is a flowchart of one embodiment of a method for locating, modifying, or replacing a barcode of a PDF file, according to the invention.

### DETAILED DESCRIPTION

The present invention is directed to the area of identifying and tagging barcodes in a PDF file and using the PDF files to identify or modify the barcodes. The present invention is also directed to methods and systems for identifying and tagging barcodes in a PDF file and using the PDF files to identify or modify the barcodes.

The methods, systems, and devices described herein may be embodied in many different forms and should not be construed as limited to the embodiments set forth herein. Accordingly, the methods, systems, and devices described herein may take the form of an entirely hardware embodiment, an entirely software embodiment or an embodiment combining software and hardware aspects. The methods described herein can be performed using any type of processor and any suitable type of device that includes a processor.

A “barcode” is a machine-readable representation of numerals, characters, symbols, or the like using geometric shapes, such as rectangles, lines, dots, hexagons, or the like. Each barcode is connected to a symbology which associates each barcode symbol with one or more numerals, characters, symbols, or the like. The symbology of a barcode may also dictate physical features (e.g., height, width, or the like) and arrangement of elements of the barcode. Examples of barcodes include one-dimensional (1D) and two-dimensional (2D) barcodes. 1D barcodes include, but are not limited to, barcodes with the following symbologies: EAN, UPC, POSTNET, PLANET, Code 128 or other known Codes, or the like or any combination thereof. 2D barcodes include, but are not limited to, barcodes with the following symbologies: QR codes, Data Matrix, DotCode, PDF417, or the like or any combination thereof.

A barcode can be included in a PDF file in a variety of different ways. For example, the barcode can be included as an image. In at least some instances, the image contains black and white pixels to represent bars or modules within the barcode, although pixels of other colors may be used. As another example, a barcode can be included in a PDF file as a collection of vector fills. In at least some embodiments, the vectors fills are in the form of rectangles to represent bars or modules, although other forms can be used. As a further example, a barcode can be included using a specialist barcode font. Such barcode fonts can be used for one-dimensional barcodes or two-dimensional barcodes, such as QR Codes.

This flexibility in encoding barcodes in a PDF file can hinder identification, by a PDF reader, of a specific graphic or collection of graphics on a PDF page as representing a barcode. It is useful, however, to identify barcodes in a PDF file. For example, identification of a barcode can be used to validate that the barcode has been placed in the correct position or placed at the correct angle or rotation relative to the direction of a printing device or page or to validate that the correct bar width reduction has been applied to compensate for growth or erosion of bars and modules that may occur in the intended printing process.

As other examples, identification of a barcode can be used to validate that the barcode represents the correct data in the intended character encoding or to replace a barcode with another. For example, a barcode can be replaced with a barcode representing the same data in the same symbology but adjusted to improve print quality. As an example, many digital printers print at low resolutions when compared to offset lithographic and flexographic presses. To achieve clean, high-contrast edges (which facilitates readability of the barcode), each bar or module in the printed barcode can be painted with an integer number of device pixels. At low resolution, this places constraints on the sizes that may be achieved without risking some bars or modules being significantly smaller or larger than others because of rounding errors. If the rendering workflow includes any anti-aliasing or lossy compression each bar or module may need to be placed in the correct position relative to the device pixel grid. A barcode placed at slightly the wrong site may not be reliably readable.

Conventionally, systems processing PDF files identify barcodes by i) heuristics based on common PDF creator techniques for incorporating barcodes into PDF pages or ii) rendering the page and searching the resulting raster for elements that appear to be barcodes (using, for example, barcode detection software such as that used in retail scanning devices.) The heuristic method can miss identifying barcodes for reasons, such as, for example, a different creation tool was used, a ‘known’ creator has been upgraded and now writes the barcodes differently, or the heuristics were incomplete for that creator. The rendering technique can be relatively slow and may only identify the location on the page without specifically identifying which graphics within the PDF file itself represent the barcode. Some information about the barcode (for example, data represented, symbology, error correction, or the like) can be obtained. Other information, such as, for example, bar width reduction requirements or limitations on the size at which the barcode can be placed are generally not available.

In contrast to these conventional techniques, as described herein, metadata associated with a barcode can be attached to elements within a PDF file so that a barcode can be identified as such. In at least some embodiments, the metadata can include information to support replacement or scaling of the barcode. In at least some embodiments, the metadata, files, systems, and methods described herein can facilitate one or more of the following: relatively rapid determination that a PDF file contains one or more barcodes; relatively rapid extraction and preflight of the data represented by the barcode(s); relatively rapid extended preflight of barcode size, rotation, or the like; and provision of data to enable replacement or scaling of the barcode (for example, for workflow or quality reasons.) In at least some embodiments, the metadata, files, systems, and methods described herein can perform one or more of these features more rapidly than current conventional techniques.

In the files, systems, and methods described herein, metadata for each barcode can be provided and uniquely associated with each set of graphical elements that represent a barcode in the PDF file. In at least some embodiments, the metadata may depend on the capabilities of the tool that writes the metadata or the tool that will do barcode replacement or scaling. For example, a tool that can only replace UPC codes will often use a different set of data (with some overlap) from a tool that can replace only QR Codes.

Examples of information that can be included in the metadata include, but is not limited to, the symbology (UPC, QR Code, EAN, POSTNET, PLANET, Code 128, Data Matrix, DotCode, PDF417, or any other known or developed one-dimensional or two-dimensional barcode symbology or the like), an error correction factor (where relevant, most commonly for two-dimensional barcodes), module count (most commonly for two-dimensional codes), foreground or background colors, physical dimensions of the barcode (for example, maximum, minimum, optimum, dimensions (e.g., length or width) or any combination thereof), position of the barcode on the page, area of the barcode on the page, rotation of the barcode relative to the page, alignment information for the barcode or a replacement barcode (for example, vertical or horizontal alignment relative to the page, original barcode, original area of the barcode, or maximum size of the barcode), the data represented by the barcode (e.g., a number, website address, or other information), the text encoding to be applied to the data (the specifications for many symbologies limit text encodings, but some support multiple encodings, for example, QR Code supports ISO/IEC 8859-1 and Shift-JIS), text accompanying the barcode and features of that text (for example, the presence of the text, position of the text relative to the barcode, text font, text size, text color, or the like or any combination thereof), print-related details such as the bar width reduction to be applied, or the like. A particular metadata may include any combination of this information and may include other information that is not listed in the preceding sentence.

In at least some embodiments, the metadata includes at least the position of the barcode on at least one page, a symbology of the barcode, and data represented by the barcode. In at least some embodiments, the metadata includes at least one of the following: a rotation of the barcode on the at least one page, position of text printed with the barcode, font or size of the text, foreground or background colors of the barcode, or an error correction factor. In at least some embodiments, the metadata includes at least one of the following: a minimum physical dimension of the barcode, a maximum physical dimension of the barcode, a bar width reduction, a bar width reduction along a print direction, a bar width reduction orthogonal to the print direction, or vertical or horizontal alignment for a replacement barcode. This metadata may be particularly useful for scaling or replacement of the barcode.

In at least some embodiments, metadata specifying the minimum, maximum, or optimum physical dimensions for the barcode can facilitate automatic scaling to a different size which may be limited by features such as the resolution of the printing device or other data that will be available to the tool performing the replacement, such as anti-aliasing configurations. The term “optimum” can relate to a preferred or best physical dimensions for printing the barcode and may be dependent on factors such as the printing device or rendering device, industry regulations or guidance for that use case of the symbology, or the like or any combination thereof.

In at least some embodiments, the print-related details, such as bar width reduction, may, alternatively, be known to the software program, application, or tool performing the replacement, as it will often be a function of the printing device that will be used. In at least some embodiments, different bar width reductions are employed along the print direction of the printing device and across (e.g., orthogonal to) the print direction of the printing device.

In at least some embodiments, the metadata includes at least the position of the barcode on at least one page, a symbology of the barcode, data represented by the barcode, the text encoding to be applied to the data, an error correction factor, and bar width reduction. In at least some embodiments, the metadata also includes a rotation of the barcode relative to the page and alignment information for the barcode or a replacement barcode. Alternatively or additionally, in at least some embodiments, the metadata also includes the text accompanying the barcode and one or more features of that text, such as, for example, the presence of the text, position of the text relative to the barcode, text font, text size, text color, or the like or any combination thereof. Alternatively or additionally, in at least some embodiments, the metadata also includes the minimum, maximum, or optimum physical dimensions for the barcode.

PDF is a flexible file format and so the metadata can be embedded in the PDF file in different ways. As one example, the ISO 19593-1 standard specifies how “processing steps” can be written into a PDF file. One of the types of processing steps supported is a Barcode. “Processing Steps” are represented as PDF Optional Content Groups (OCGs) with additional metadata. Accordingly, a PDF reading tool can identify that a PDF file contains one or more Barcodes by, for example, opening the PDF file, reading the Trailer and Xref table, navigating to the Catalog, then navigating to the OCProperties dictionary, and iterating through the entries in the OCGs array looking for a metadata entry that contains GTS_ProcStepsGroup and GTS_ProcStepsType keys. In addition, a PDF SDK or toolset can identify which graphic elements within the PDF file represent each of those barcodes by, for example, walking through the Pages tree and reviewing associated XObject resources to find XObjects with an OC entry matching the name of the entry in the OCGs array.

However, the ISO 19593-1 standard does not provide any method to derive the data represented by the barcode from the PDF file. Generally, the data represented by the barcode is encoded only in the barcode itself and the different techniques and creation tools for writing the barcode into the PDF file, as well as the different symbologies, make it complex to derive the data value from the barcode in the PDF file.

In at least some embodiments, the metadata, files, systems, and methods described herein all include the metadata (such as one or more of the items of information described above) within a barcode OCG. In at least some embodiments, this metadata can be used to support validation or replacement of the barcode. One example of such metadata is provided below for the processing step OCG dictionary. (GGSL_ is a “second class name prefix” used here for convenience and can be replaced by any other suitable prefix.)

```
40 0 obj
<<
  /Type /OCG
  /Name (Barcode1)
  /GTS_Metadata
  <<
    /GTS_ProcStepsGroup /Positions
    /GTS_ProcStepsType /Barcode
  >>
  /GGSL_Barcode
  <<
    /ColorSpace /DeviceGray
    /BackgroundColor [ 1 ]
    /ForegroundColor [ 0 ]
    /Data (Content of the placeholder barcode)
    /Encoding (Latin1) % = ISO/IEC 8859-1
    /Symbology /qrcode
    /ErrorCorrection 3
    /TargetWidthHeight [ 60 60 ] % in points
    /MinimumWidthHeight [ 50 50 ]
    /HorizontalAlignment /Center
    /VerticalAlignment /Center
    /HorizontalEdgeGrowth −1
    /VerticalEdgeGrowth 1
    /ShowText false
  >>
>>
endobj
```

In at least some embodiments, the barcode placeholder can be formatted as a Form XObject with an OC (optional content) entry, and the XObject BBox array can be written to represent the maximum area that the barcode may cover. In at least some embodiments, a barcode replacement code will select the nearest size to TargetWidthHeight to ensure that the barcode width is an integer multiple of the number of modules across, and, for two-dimensional barcodes, the height is an integer multiple of the number of modules vertically, that falls within the range between MinimumWidthHeight and the maximum width and height as specified by the XObject BBox entry.

The PDF format is flexible and there are several additional methods or techniques for adding the metadata associated with the barcode in a PDF file. As another example, the metadata can be included in the Form or Image XObject dictionary that encodes the graphical elements to draw the barcode rather than in a processing steps OCG (optional content group). In at least some embodiments, this can be used in combination with an (un-extended) barcode processing steps OCG (optional content group).

As further example, a unique identifier (e.g., using a UUID—universally unique identifier) is added to the processing steps OCG or to the XObject and the metadata is recorded as XMP (extensible metadata platform) in a metadata stream at the document level, page level, parent Form XObject level, or the like within the PDF file, including the same unique identifier in that metadata. As yet another example, a unique identifier is added to the processing steps OCG or to the XObject and the metadata and unique identifier are recorded using a PDF object structure within a document Catalog, Page object, parent Form XObject, or the like.

In at least some embodiments, a writing system adds or embeds the metadata within the PDF file. In at least some embodiments, a reading system (which could be the same or different from the writing system) reads the metadata and my act or provide user actions based on the metadata.

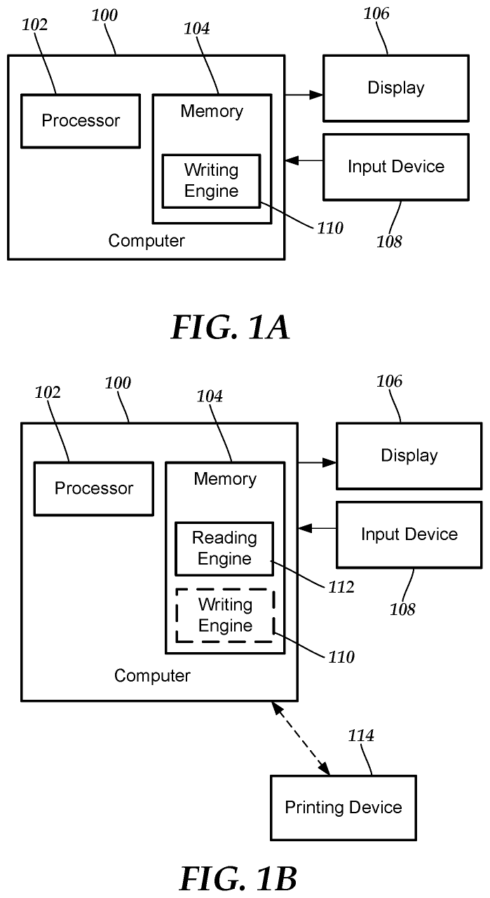

FIG. 1A illustrates one embodiment of a writing system and FIG. 1B illustrates one embodiment of a reading system. Each of these reading and writing systems can include a computer 100 or any other device that includes a processor 102 and a memory 104, a display 106, and an input device 108. Some systems can include more or fewer components. In FIG. 1B, the reading system can be coupled to a printing device 114, such as a printer or press. The printing device 114 can be a digital press (for example, electrophotographic or inkjet presses), a conventional press (for example, (offset lithographic, flexographic, or gravure presses), an inkjet device, a laser printing device, or any other suitable printing device. Unless otherwise indicated, the terms “printing device” and “press” are used interchangeably herein. It will be understood that the writing system of FIG. 1A can also be coupled to a printing device 114. In some embodiments, one or more of the computer 100, display 106, or input device 108 can be part of the printing device 214.

The computer 100 can be a laptop computer, desktop computer, server computer, tablet, mobile device, smartphone, or other devices that can run applications or programs, or any other suitable device for processing information and for presenting a user interface. Alternatively or additionally, the computer 100 can be part of the printing device 114 or coupled (by wired or wireless coupling) to the printing device. The computer 100 can be local to the user or can include components that are non-local to the user including one or both of the processor 102 or memory 104 (or portions thereof). For example, in some embodiments, the user may operate a terminal that is connected to a non-local computer. In other embodiments, the memory can be non-local to the user.

The computer 100 can utilize any suitable processor 102 including one or more hardware processors that may be local to the user or non-local to the user or other components of the computer. The processor 102 is configured to execute instructions provided to the processor, as described below.

Any suitable memory 104 can be used for the computer 100. The memory 104 illustrates a type of computer-readable media, namely computer-readable storage media. Computer-readable storage media may include, but is not limited to, nonvolatile, non-transitory, removable, and non-removable media implemented in any method or technology for storage of information, such as computer readable instructions, data structures, program modules, or other data. Examples of computer-readable storage media include RAM, ROM, EEPROM, flash memory, or other memory technology, CD-ROM, digital versatile disks (“DVD”) or other optical storage, magnetic cassettes, magnetic tape, magnetic disk storage or other magnetic storage devices, or any other medium which can be used to store the desired information and which can be accessed by a computer.

Communication methods provide another type of computer readable media; namely communication media. Communication media typically embodies computer-readable instructions, data structures, program modules, or other data in a modulated data signal such as a carrier wave, data signal, or other transport mechanism and include any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

The display 106 can be any suitable display device, such as a monitor, screen, display, or the like. The input device 108 can be, for example, a keyboard, mouse, touch screen, track ball, joystick, voice recognition system, or any combination thereof, or the like and can be used by the user to interact with a user interface.

The writing system of FIG. 1A (and optionally the reading system of FIG. 1B) includes a writing engine 110 stored as instructions in the memory 104 which are executed in the processor 102. The writing engine 110 can include an application that creates or modifies a PDF file including adding or modifying metadata in the PDF file for one or more barcodes. In at least some embodiments, the metadata includes at least one of a position of the barcode on at least one page, a symbology of the barcode, and data represented by the barcode. In at least some embodiments, the metadata includes at least one of a rotation of the barcode on the at least one page, position of text printed with the barcode, font or size of the text, foreground or background colors of the barcode, or an error correction factor. In at least some embodiments, the metadata includes at least one of a minimum physical dimension of the barcode, a maximum physical dimension of the barcode, a bar width reduction, a bar width reduction along a print direction, a bar width reduction orthogonal to the print direction, or vertical or horizontal alignment for a replacement barcode.

For example, a SDK (software development kit) or toolkit that currently adds or edits barcodes and then writes graphics to PDF can be provided or modified to add the barcode metadata described above to a PDF file or modify the barcode metadata of a PDF file. In at least some embodiments, a portion or all of the information that is to be provided as barcode metadata is accessible by the SDK or toolkit based on the barcode itself, such as, but not limited to, the symbology, color, data associated with the barcode, error correction, or the like or any combination thereof. In at least some embodiments, this information can be used for generating the barcode to be included in the PDF. Additional information, such as, but not limited to, scaling for quality, may be provided by a user (e.g., through a user interface), an API (application programming interface), or any other suitable source.

The reading system of FIG. 1B includes a reading engine 112 stored as instructions in the memory 104 which are executed in the processor 102. The reading engine 112 can include an application that is capable of searching a PDF file to extract metadata for a barcode and is capable of locating a barcode in the PDF using the metadata. In at least some embodiments, the reading system of FIG. 1B also includes a writing engine 110 that is capable of modifying or replacing the barcode in the PDF file.

Any suitable PDF reader can be used to read the metadata in the PDF file. For example, a PDF editor can read the PDF file and metadata and prepare the barcode for printing using the metadata and the printing system or device. In at least some embodiments, the PDF editor can modify the metadata based on the printing system or device and produce a new or modified PDF file. In at least some embodiments, a PDF editor can read a PDF file and generate a new variable data PDF file by including multiple copies of the bulk of the incoming PDF page(s), each with a different barcode, representing different data. The same process may also replace or add text and images. In at least some embodiments, a PDF renderer (RIP) can read a PDF file and replace a place-holder barcode with a version that is better or appropriate for the printing system that the RIP is rendering for. In at least some embodiments, the replacement may involve scaling so that module widths and heights are integer multiples of device pixels and may involve application of bar width reduction or growth.

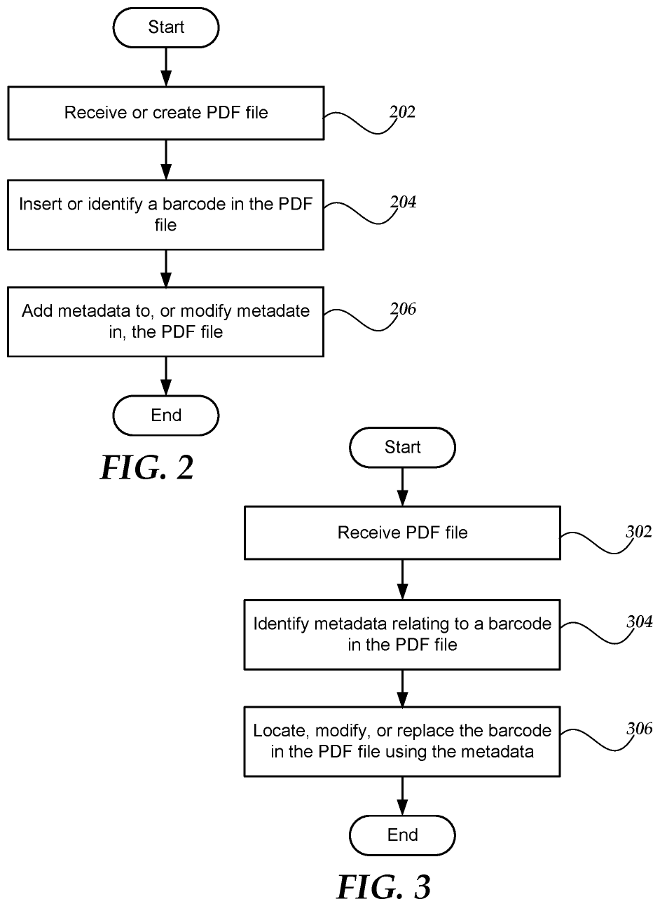

FIG. 2 illustrates one embodiment of a method for creating or modifying a PDF file. In step 202, the PDF file is received or created. The PDF file can be created using any suitable PDF creator or editor applications or software. In step 204, a barcode is inserted or identified in the PDF file. In step 206, metadata is added to, or modified in, the PDF file to include metadata about the barcode as described above. For example, the metadata can include a position of the barcode on at least one page, a symbology of the barcode, and data represented by the barcode. The metadata can include at least one of a rotation of the barcode on the at least one page, position of text printed with the barcode, font or size of the text, foreground or background colors of the barcode, or an error correction factor. The metadata can include at least one of a minimum physical dimension of the barcode, a maximum physical dimension of the barcode, a bar width reduction, a bar width reduction along a print direction, a bar width reduction orthogonal to the print direction, or vertical or horizontal alignment for a replacement barcode. Steps 204 and 206 can be repeated for any additional barcodes to be added to, or identified in, the PDF file. Various methods and arrangements for including the metadata in the PDF file are presented above.

FIG. 3 illustrates one embodiment of a method for locating, modifying, or replacing a barcode of a PDF file. In step 302, the PDF file is received. In step 304, metadata relating to the barcode is identified in the PDF file. Various methods and arrangements for including the metadata in the PDF file are presented above. In step 306, the barcode is located, modified, or replaced in the PDF file using the metadata. Various methods for locating, modifying, or replacing a barcode in a PDF file are presented above.

It will be understood that each block of the flowchart illustrations, and combinations of blocks in the flowchart illustrations and methods disclosed herein, can be implemented by computer program instructions. These program instructions may be provided to a processor to produce a machine, such that the instructions, which execute on the processor, create means for implementing the actions specified in the flowchart block or blocks disclosed herein. The computer program instructions may be executed by a processor to cause a series of operational steps to be performed by the processor to produce a computer implemented process. The computer program instructions may also cause at least some of the operational steps to be performed in parallel. Moreover, some of the steps may also be performed across more than one processor, such as might arise in a multi-processor computer system. In addition, one or more processes may also be performed concurrently with other processes, or even in a different sequence than illustrated without departing from the scope or spirit of the invention.

The computer program instructions can be stored on any suitable computer-readable medium including, but not limited to, RAM, ROM, EEPROM, flash memory or other memory technology, CD-ROM, digital versatile disks (“DVD”) or other optical storage, magnetic cassettes, magnetic tape, magnetic disk storage or other magnetic storage devices, or any other medium which can be used to store the desired information and which can be accessed by a computer.

The above specification provides a description of the manufacture and use of the invention. Since many embodiments of the invention can be made without departing from the spirit and scope of the invention, the invention also resides in the claims hereinafter appended.

1. A method for creating or modifying a PDF file, the method comprising:
inserting or identifying a barcode in the PDF file; and
adding metadata to, or modifying metadata in, the PDF file for the barcode, wherein the metadata comprises a position of the barcode on at least one page, a symbology of the barcode, data represented by the barcode, and at least one of a minimum physical dimension of the barcode or a maximum physical dimension of the barcode.

2. The method of claim 1, wherein the metadata further comprises at least one of a rotation of the barcode on the at least one page, position of text printed with the barcode, font or size of the text, foreground or background colors of the barcode, or an error correction factor.

3. The method of claim 1, wherein, to facilitate scaling or replacement of the barcode, the metadata further comprises at least one of a bar width reduction along a print direction, a bar width reduction orthogonal to the print direction, or vertical or horizontal alignment for a replacement barcode.

4. The method of claim 1, wherein adding the metadata comprises adding the metadata to an optional content group (OCG) that encodes graphical elements of the barcode in the PDF file.

5. The method of claim 1, wherein adding the metadata comprises adding the metadata to a Form or Image XObject that encodes graphical elements of the barcode.

6. The method of claim 1, wherein adding the metadata comprises adding the metadata and a unique identifier as extensible metadata platform (XMP) in a metadata stream at a document level, page level, or parent Form XObject level of the PDF file.

7. The method of claim 1, wherein adding the metadata comprises adding the metadata and a unique identifier using a PDF object structure or JSON stream within a document catalog, page object, or parent Form XObject.

8. A method for locating, modifying, or replacing a barcode of a PDF file, the method comprising:
identifying metadata in the PDF file corresponding to the barcode, wherein the metadata comprises a position of the barcode on at least one page, a symbology of the barcode, data represented by the barcode, and at least one of a minimum physical dimension of the barcode or a maximum physical dimension of the barcode; and
locating, modifying, or replacing the barcode in the PDF file using the metadata.

9. The method of claim 8, wherein locating, modifying, or replacing the barcode comprises scaling the barcode limited by the minimum physical dimension or the maximum physical dimension in the metadata.

10. The method of claim 8, wherein the metadata further comprises at least one of a rotation of the barcode on the at least one page, a bar width reduction, a bar width reduction along a print direction, or a bar width reduction orthogonal to the print direction.

11. The method of claim 10, wherein locating, modifying, or replacing the barcode comprises scaling modules of the barcode utilizing any of the bar width reductions in the metadata.

12. The method of claim 8, wherein the metadata further comprises at least one of vertical or horizontal alignment for a replacement barcode.

13. The method of claim 12, wherein locating, modifying, or replacing the barcode comprises replacing the barcode with a replacement barcode utilizing at least one of the location of the barcode on the at least one page or the vertical or horizontal alignment for the replacement barcode in the metadata.

14. The method of claim 8, wherein locating, modifying, or replacing the barcode comprises generating a variable data PDF file by including multiple instances of the PDF file and replacing the barcode in each of the instances with a different replacement barcode using the metadata.

15. The method of claim 8, further comprising printing the PDF file.

16. A system, comprising:
at least one memory having instructions stored thereon; and
at least one processor coupled to the at least one memory and configured to execute the instructions to perform the method of claim 1.

17. A system, comprising:
at least one memory having instructions stored thereon; and
at least one processor coupled to the at least one memory and configured to execute the instructions to perform the method of claim 8.

18. The system of claim 17, further comprising a printing device, wherein the instructions further comprise printing the PDF file.

19. A non-transitory computer-readable medium having processor-executable instructions for creating or modifying a PDF file, the processor-executable instructions when installed onto a device enable the device to perform the method of claim 1.

20. A non-transitory computer-readable medium having processor-executable instructions for locating, modifying, or replacing a barcode of a PDF file, the processor-executable instructions when installed onto a device enable the device to perform the method of claim 8.
